(19) United States
(12) Patent Application Publication
(10) Pub. No.: US 2015/0201797 A1
(43) Pub. Date: Jul. 23, 2015

(54) SOYMILK MACHINE AND METHOD FOR MAKING SOYMILK

(71) Applicant: KONINKLIJKE PHILIPS N.V., EINDHOVEN (NL)

(72) Inventors: Changjie Wang, Eindhoven (NL); Xiaoyun Kui, Eindhoven (NL); Donghai Yu, Eindhoven (NL)

(21) Appl. No.: 14/414,616

(22) PCT Filed: Jul. 8, 2013
(86) PCT No.: PCT/IB2013/055567

§ 371 Date: Jan. 13, 2015

(30) Foreign Application Priority Data
Jul. 18, 2012 (CN) PCT/CN2012/000969

(51) Int. Cl. A47J 31/56; A23C 11/10

(52) U.S. Cl. CPC A47J 31/56; A23C 11/103

(57) ABSTRACT

The present invention relates to a method for making soymilk with a soymilk machine, said soymilk machine (200) comprising a level sensor (204) and a heating device (203), said method comprises steps: obtaining a measured value by said level sensor, said measured value being positively correlated with resistance between said level sensor and liquid in said soymilk machine; comparing said measured value with a first threshold when the temperature of said liquid is lower than a first preset temperature; comparing said measured value with a second threshold when the temperature of said liquid is higher than said first preset temperature; adjusting the power of said heating device if said measured value is lower than or equal to the first threshold when the temperature of said liquid is lower than the first preset temperature; adjusting the power of said heating 201 device if said measured value is lower than or equal to the second threshold when the temperature of said liquid is higher than the first preset temperature. The present invention also relates to a home soymilk machine corresponding to said method.

### FIELD OF THE INVENTION

The invention relates to an apparatus for making beverages and a method for making beverages, in particular, to a soymilk machine and a method for making soymilk.

### BACKGROUND OF THE INVENTION

Soymilk contains many high quality proteins, vitamins, amino acids and trace elements and thus has very high nutritional value, so it is an ideal health food. As food safety problems increase nowadays and people's consciousness of healthy green lifestyle has toned up gradually, people often choose homemade soymilk in concern of hygiene and safety. Home soymilk machine is becoming more and more poplar in Asian countries. The demands for soymilk machine have driven the market of the home soymilk machine to grow rapidly.

Cooking phase is very important in soymilk making process. Normal soymilk machine will cook the raw soymilk to boiling and keep the temperature for more than 10 minutes. This process is employed to remove those inhibitors in the soybeans and make the soymilk safe for drinking.

However, during the cooking phase, soymilk is very easy to overflow because of boiling. To avoid overflow, current soymilk machine installs a level sensor. When the liquid surface reaches the level sensor, the measured value of the level sensor (such as value of voltage, current, etc.) will be derived from the measuring circuit, resulting in the shutting down of the heating power. After certain seconds, when the liquid surface is lower, the heating process resumes. By repeating this cooking for around 10 minutes, the raw soymilk can be cooked thoroughly.

### SUMMARY OF THE INVENTION

However, even with a level sensor, there are still problems existing in current mechanism. In the early phase of the soymilk making process, high strength grinding is typically utilized, thus the bubble or the liquid surface is apt to reach the level sensor even the temperature is relatively low. In this case, the liquid is not apt to boil; hence, the overflow due to the boiling liquid will not happen so soon. Shutting down the heating power too early will extend the overall time of soymilk making.

When cold grinding mode or high strength grinding mode is applied for higher protein extraction rate, there will be more problems. Compared to hot grinding, bigger bubbles and more foams are generated during cold grinding or high strength grinding. Thus, heating device will be shut down even the temperature is still very low. After cold grinding, normally, raw soymilk needs to be heated and kept boiling for several minutes to inactivate those anti-nutrients. However, because too many bubbles and foams reach the level sensor, the system will detect the change of voltage and stop heating, even the temperature is still low. Therefore, it takes long time to wait for the elimination of foams and bubbles until the temperature reaches the boiling point. With current commercial soymilk machine design, usually, the temperature of raw soymilk can hardly reach the boiling temperature, and finally the soymilk made is not safe for drinking.

It is an object of the invention to provide a soymilk machine and a method for making soymilk, which allows flexible combination of heating power, grinding strength and level sensor setting for optimized heating/cooking process. Furthermore, since there is not much change on hardware of current soymilk machine, the cost of implementing this invention is relatively low.

A basic idea of the invention is to use different thresholds to adjust heating power in different phases of soymilk making process. Said different phases can be divided by a first preset temperature. Furthermore, different threshold settings are implemented for different heating/cooking stages, to achieve anti-overflow function, and enable real high temperature cooking. This also helps to reduce total making time, especially for the situations in which there are more foams/bubbles than expected.

In order to achieve the above object, an embodiment of the invention provides a method for making soymilk with a soymilk machine, said soymilk machine comprising a level sensor and a heating device, said method comprises: obtaining a measured value by said level sensor, said measured value being positively correlated with resistance between said level sensor and liquid in said soymilk machine; comparing said measured value with a first threshold when the temperature of said liquid is lower than a first preset temperature; comparing said measured value with a second threshold when the temperature of said liquid is higher than said first preset temperature; adjusting the power of said heating device if said measured value is lower than or equal to the first threshold when the temperature of said liquid is lower than the first preset temperature; adjusting the power of said heating device if said measured value is lower than or equal to the second threshold when the temperature of said liquid is higher than the first preset temperature.

Another embodiment of the invention provides a home soymilk machine, comprising:
a container;
a grinding device;
a heating device;
a level sensor for obtaining a measured value, said measured value being positively correlated with resistance between said level sensor and liquid in said soymilk machine;
   a micro controller unit for
comparing said measured value with a first threshold when the temperature of said liquid is lower than a first preset temperature; comparing said measured value with a second threshold when the temperature of said liquid is higher than said first preset temperature;
and adjusting the power of said heating device if said measured value is lower than or equal to the first threshold when the temperature of said liquid is lower than the first preset temperature; adjusting the power of said heating device if said measured value is lower than or equal to the second threshold when the temperature of said liquid is higher than the first preset temperature.

These and other aspects of the invention will be apparent from and elucidated with reference to the embodiments described hereinafter.

The invention will be described in detail hereinafter with reference to exemplary embodiments. However, the invention is not limited to these exemplary embodiments.

### BRIEF DESCRIPTION OF THE DRAWINGS

The present invention will now be described based on various embodiments with reference to the accompanying drawings, in which:

FIG. 1 is a schematic flowchart of the cooking phase of the soymilk making process according to an embodiment of the invention;

FIG. 2 is a schematic sectional view showing the soymilk machine according to an embodiment of the invention.

### DETAILED DESCRIPTION OF THE INVENTION

Reference will now be made to embodiments of the disclosure, one or more examples of which are illustrated in the figures. The embodiments are provided by way of explanation of the disclosure, and are not meant as a limitation of the disclosure. For example, features illustrated or described as part of one embodiment may be used with another embodiment to yield still a further embodiment. It is intended that the disclosure encompass these and other modifications and variations as come within the scope and spirit of the disclosure.

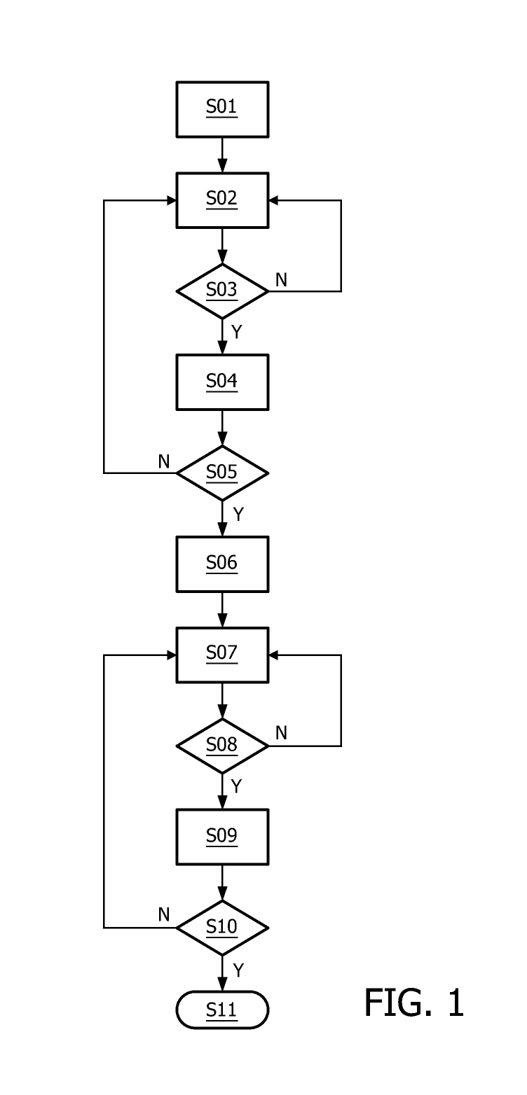

Embodiments of the present invention are described on the basis of an examplary method for making soymilk with soymilk machine as shown in FIG. 1.

FIG. 1 is a schematic flowchart of the cooking phase of the soymilk making process according to an embodiment of the invention. In which the cooking phase of the soymilk making process may comprise:
S01: Start cooking phase
S02: Heating
S03: Measured value≦1st threshold?
S04: Reduce heating power
S05: Temperature≧preset value?
S06: T=0
S07: Heating
S08: Measured value≦2nd threshold?
S09: Reduce heating power
S10: T≧480 seconds?
S11: End

The soymilk machine may have a level sensor, which may comprise a measuring circuit (or cooperate with a measuring circuit). By measuring the resistance of the liquid in the container of the soymilk machine (i.e. the resistance between the level sensor and the Ground) or other initially equivalent parameters, the measuring circuit may obtain a measured value positively correlated with resistance between said level sensor and liquid in said soymilk machine. Alternatively, the level sensor can be connected in series with a reference resistor, and the measuring circuit can measure the voltage/potential drop between the level sensor and the Ground. When liquid in the soymilk machine rises and reaches the level sensor, the resistance (or said voltage/potential drop) is reduced to a certain value. A micro controller unit (MCU) may receive the measured value and compares the measured value with a predetermined threshold.

Those skilled in the art should understand, if the measuring circuit measures a parameter negatively correlated with resistance between said level sensor and liquid in said soymilk machine (such as the voltage/potential drop of the reference resistor, etc.), then the parameter can readily be transformed to be a measured value positively correlated with resistance between said level sensor and liquid in said soymilk machine.

The liquid in the container of the soymilk machine can be heated in a pre-heating phase, thus the temperature of the liquid rises continuously. When the temperature of the liquid rises to a certain value (such as a value between 65° C.-70° C., preferably 68° C.), the cooking phase of the soymilk making process begins.

The liquid in this disclosure refers to the mixture comprising raw ingredients and solvent. The raw ingredients may for example be soybeans, black soybeans, a mixture of soybeans and vegetables, a mixture of soybeans and fruits, a mixture of soybeans and grains, or any combination of those ingredients. The solvent may for example be water, mineral water, tap water, alkaline water, salted water, alcohol, or any combination of those solvents.

As shown in FIG. 1, the cooking phase of the soymilk making process comprises a first cooking phase (S01-S05) and a second cooking phase (S06-S11) in sequence. At the beginning of the first cooking phase, the heating power is on for increasing the temperature of the liquid quickly (S02), preferably with low strength grinding for stiffing purpose.

During the first cooking phase, measured value is obtained by said level sensor, and said measured value is compared with a first threshold. If the measured value of the level sensor is lower than or equal to the first threshold, heating power will be reduced or even be shut down (S04), thus overflow of the liquid will be avoided. Heating can be resumed if heating power is reduced for a certain time interval. Alternatively, heating can be resumed if the measured value of the level sensor rises above the first threshold. In this way, the temperature of the liquid rises quickly by stages, while overflow of the liquid can be avoided.

Preferably, both moderate heating and low strength grinding in this phase can be used to avoid solid content in soymilk sticking to surface of the heating device and getting burned. When the temperature of the liquid is around 90° C., due to the chemical compounds as well as bubbles generated by grinding, there will be lots of foams in the first cooking phase, which will rise and reach the level sensor. Considering the heating pattern and actual temperature, even the foams reach the level sensor, there is low possibility to really overflow. Therefore, the level sensor should be set in a “low sensitivity” mode. That is, the first threshold should be a relatively low value; such that even many foams or thicker mixture reaches the level sensor, the heating power will not be reduced too early.

In a preferred embodiment, the method comprises comparing the temperature of said liquid with a preset temperature. When the temperature of the liquid is higher than the preset value (such as a value between 95° C.-97° C., preferably 96° C.), the second cooking phase begins and a timer is set as T=0 (S06). During the second cooking phase, the temperature of the whole liquid should be kept on a relatively high value (such as 98° C.-100° C., preferably 99° C.-100° C.) for a certain time interval to fully inactivate those non-drinkable compounds.

At the beginning of the second cooking phase, the heating power is still on for increasing the temperature of the liquid to a higher value (S07).

During the second cooking phase, measured value is obtained by said level sensor, and said measured value is compared with a second threshold. If the measured value of the level sensor is lower than or equal to the second threshold, heating power will be reduced or even be shut down(S09), thus overflow of the liquid will be avoided. Heating can be resumed if heating power is reduced for a certain time interval. Alternatively, heating can be resumed if the measured value of the level sensor rises above the second threshold. In this way, the temperature of the liquid can be maintained on a relatively high value, while overflow of the liquid can be avoided.

In the second cooking phase, due to the relatively high temperature, the soymilk is apt to overflow; therefore, slow heating pattern should be utilized. For the same reason, the level sensor should also be set in a “high sensitivity” mode. That is, the second threshold should be a relatively high value; such that even few foams or thinner mixture reaches the level sensor, the heating power will be reduced immediately. Therefore, compared with the first cooking phase, the second threshold should be substantially greater than the first threshold to ensure slow heating pattern while prevent the liquid in the soymilk machine from overflowing.

Preferably, heating power of the soymilk machine during the first cooking phase can be higher than heating power of the soymilk machine during the second cooking phase. Thus, the temperature of the liquid can rise quickly in the first cooking phase due to low possibility of overflow; and the temperature of the liquid can be maintained at a relatively stable temperature in the second phase due to high possibility of overflow.

Optionally, prior to the cooking phase which comprises the first cooking phase and the second cooking phase (i.e. the temperature of the liquid is lower than a second preset temperature, wherein said second preset temperature is lower than said first preset temperature, such as 68° C. mentioned before), the soymilk making process may further comprise a pre-heating phase and a cold grinding phase in sequence. Due to the relatively low temperature during the pre-heating phase and the cold grinding phase, the level sensor may be disabled (i.e. the level sensor may not be enabled or the measured value of the level sensor can be neglected).

After a period (such as about 480 seconds) from the beginning of the second cooking phase, the cooking phase of the soymilk making process can be finished (S11).

As a result of this arrangement, the total making time of soymilk can be reduced, especially for soymilk making process of cold grinding mode or high strength grinding mode.

In an exemplary embodiment, the soymilk making process may comprises: pre-heating phase: full power heating is started until reaching a target temperature, such as 68° C.;

cold grinding phase: full power grinding is used for water extraction of protein and other nutrients. In the cold grinding phase, heating is stopped or heating power is reduced, and the level sensor is disabled (i.e. the level sensor is not enabled or the measured value of the level sensor is neglected);

first cooking phase: after water extraction, heating of moderate pattern is started. For example, 60% heating power is used. During the first cooking phase, grinding (in low strength) is performed several times for stirring purpose. Both moderate heating and low strength grinding in this phase are used to avoid solid content in soymilk sticking to surface of the heating device and getting burned. When the measured value of the level sensor is lower than or equal to a first threshold, heating power will be reduced, thus overflow of the liquid will be avoided. Heating is resumed for example, after 3 seconds idle. Alternatively, heating can be resumed if the measured value of the level sensor rises above the first threshold;

second cooking phase: when temperature reaches 95° C., the second cooking phase begins. Heating of slow pattern is started, for example, 25% heating power is used. The second cooking phase is used to fully cook the soymilk to inactivate non-drinkable compounds. When the measured value of the level sensor is lower than or equal to a second threshold, heating power will be reduced, thus overflow of the liquid will be avoided. Heating is resumed for example, after 3 seconds idle. Alternatively, heating can be resumed if the measured value of the level sensor rises above the first threshold. In this way, the temperature of the liquid can be maintained on a relatively high value, while overflow of the liquid can be avoided.

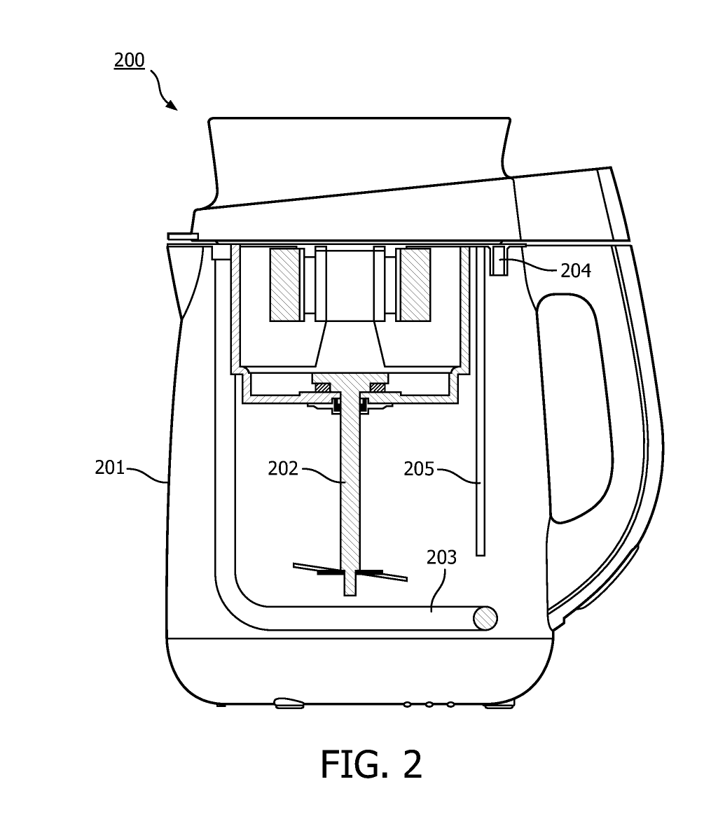

Embodiments of the present invention are now described on the basis of an exemplary home soymilk machine as shown in FIG. 2.

Fig. 2 is a schematic sectional view showing the soymilk machine according to an embodiment of the invention. The soymilk machine 200 comprises: a container 201 for containing raw ingredients and solvent, a grinding device 202 for grinding the raw ingredients or stiffing the liquid in the container 201, a heating device 203 for heating the liquid in the container, and a level sensor 204 set in the container for measuring relevant parameter (i.e. measured value). The level sensor 204 may comprise a measuring circuit (not shown), or cooperate with a measuring circuit. By measuring the resistance of the liquid in the container of the soymilk machine (i.e. the resistance between the level sensor and the Ground) or other initially equivalent parameters, the measuring circuit may obtain a measured value positively correlated with resistance between said level sensor and liquid in said soymilk machine. Alternatively, the level sensor 204 can be connected in series with a reference resistor, and the measuring circuit can measure the voltage/potential drop between the level sensor 204 and the Ground. When liquid in the soymilk machine rises and reaches the level sensor 204, the resistance (or said voltage/potential drop) is reduced to a certain value. A micro controller unit (MCU, not shown) may compare the temperature of said liquid with a first preset temperature. The micro controller unit may also compare said measured value with a first threshold when the temperature of said liquid is lower than the first preset temperature, compare said measured value with a second threshold when the temperature of said liquid is higher than said first preset temperature, and adjust the power of said heating device if said measured value is lower than or equal to the first/second threshold.

Those skilled in the art should understand, if the measuring circuit measures a parameter negatively correlated with resistance between said level sensor and liquid in said soymilk machine (such as the voltage/potential drop of the reference resistor, etc.), then the parameter can readily be transformed to be a measured value positively correlated with resistance between said level sensor and liquid in said soymilk machine.

Typically, the liquid in the container of the soymilk machine can be heated in a pre-heating phase, thus the temperature of the liquid rises continuously. The temperature of the liquid can be measured with a temperature measuring device 205 which is set on the machine head or on the side wall of the container. The temperature of the liquid can also be derived from parameters such as the heating power and the heating time. When the temperature of the liquid rises to a certain value (such as a value between 65° C.-70° C., preferably 68° C.), the cooking phase of the soymilk making process begins.

The cooking phase of the soymilk making process can comprise a first cooking phase and a second cooking phase in sequence. At the beginning of the first cooking phase, the heating power is still on for increasing the temperature of the liquid quickly, preferably with low strength grinding for stirring purpose.

During the first cooking phase, measured value is obtained by said level sensor, and said measured value is compared with a first threshold. If the measured value of the level sensor is lower than or equal to the first threshold, heating power will be reduced or even be shut down, thus overflow of the liquid will be avoided. Heating can be resumed if heating power is reduced for a certain time interval. Alternatively, heating can be resumed if the measured value of the level sensor rises above the first threshold. In this way, the temperature of the liquid rises quickly by stages, while overflow of the liquid can be avoided.

Preferably, both moderate heating and low strength grinding in this phase can be used to avoid solid content in soymilk sticking to surface of the heating device 203 and getting burned. When the temperature of the liquid is around 90° C., due to the chemical compounds as well as bubbles generated by grinding, there will be lots of foams in the first cooking phase, which will rise and reach the level sensor. Considering the heating pattern and actual temperature, even the foams reach the level sensor, there is low possibility to really overflow. Therefore, the level sensor should be set in a “low sensitivity” mode. That is, the first threshold should be a relatively low value; such that even many foams or thicker mixture reaches the level sensor, the heating will not be stopped too early.

In a preferred embodiment, when the temperature of the liquid is higher than a preset value (such as a value between 95° C.-97° C., preferably 96° C.), the second cooking phase begins. During the second cooking phase, the temperature of the liquid should be kept on a relatively high value (such as 98° C.-100° C., preferably 99° C.-100° C.) for a certain time interval to fully inactivate those non-drinkable compounds.

At the beginning of the second cooking phase, the heating power is still on for increasing the temperature of the liquid to a higher value.

During the second cooking phase, measured value is obtained by said level sensor, and said measured value is compared with a second threshold. If the measured value of the level sensor is lower than or equal to the second threshold, heating power will be reduced or even be shut down, thus overflow of the liquid will be avoided. Heating can be resumed if heating power is reduced for a certain time interval. Alternatively, heating can be resumed if the measured value of the level sensor rises above the second threshold.

In this way, the temperature of the liquid can be maintained on a relatively high value, while overflow of the liquid can be avoided.

In the second cooking phase, due to the relatively high temperature, the soymilk is apt to overflow; therefore, slow heating pattern should be utilized. For the same reason, the level sensor 204 should also be set in a “high sensitivity” mode. That is, the second threshold should be a relatively high value; such that even few foams or thinner mixture reaches the level sensor 204, the heating power will be reduced immediately. Therefore, compared with the first cooking phase, the second threshold should be substantially greater than the first threshold to ensure slow heating pattern while prevent the liquid in the soymilk machine from overflowing.

Preferably, heating power of the soymilk machine during the first cooking phase can be higher than heating power of the soymilk machine during the second cooking phase. Thus, the temperature of the liquid can rise quickly in the first cooking phase due to low possibility of overflow; and the temperature of the liquid can be maintained at a relatively stable temperature in the second phase due to high possibility of overflow.

Optionally, prior to the cooking phase which comprises the first cooking phase and the second cooking phase, the soymilk making process may further comprise a pre-heating phase and a cold grinding phase in sequence. Due to the relatively low temperature during the pre-heating phase and the cold grinding phase, the level sensor 204 may be disabled (i.e. the level sensor 204 may not be enabled or the measured value of the level sensor 204 can be neglected).

After a period (such as about 480 seconds) from the beginning of the second cooking phase, the cooking phase of the soymilk making process can be finished by the MCU. As a result of this arrangement, the total making time of soymilk can be reduced, especially for soymilk making process of cold grinding mode or high strength grinding mode.

The beneficial effects of the present invention are as follows: anti-overflow function and fully high temperature cooking are achieved based on unique threshold setting for each phase of the soymilk making process. The total making time is also shortened, especially for the cases in which there are more foams/bubbles than expected. Optimized soymilk making process can be achieved due to flexible combination of heating power, grinding strength and level sensor setting.

While the invention has been illustrated and described in detail in the drawings and foregoing description, such illustration and description are to be considered illustrative or exemplary and not restrictive; the invention is not limited to the disclosed embodiments.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. A method of making soymilk with a soymilk machine, said soymilk machine comprising a level sensor and a heating device, said method comprises steps:
a. obtaining a measured value by said level sensor, said measured value being positively correlated with resistance between said level sensor and liquid in said soymilk machine;
c. comparing said measured value with a first threshold when the temperature of said liquid is lower than a first preset temperature; comparing said measured value with a second threshold when the temperature of said liquid is higher than said first preset temperature;
d. adjusting the power of said heating device if said measured value is lower than or equal to the first threshold when the temperature of said liquid is lower than the first preset temperature; adjusting the power of said heating device if said measured value is lower than or equal to the second threshold when the temperature of said liquid is higher than the first preset temperature.

2. The method according to claim 1, wherein said second threshold is greater than the first threshold; and the power of said heating device is reduced to adjust the power of said heating device in step d.

3. The method according to claim 1, wherein the heating power in the case of the temperature of said liquid being higher than said first preset temperature is lower than the heating power in the case of the temperature of said liquid being lower than said first preset temperature.

4. The method according to claim 1, wherein said first preset temperature is between 95° C. and 97° C.

5. The method according to claim 1, wherein said level sensor is disabled when the temperature of said liquid is lower than a second preset temperature, and said second preset temperature is lower than said first preset temperature.

6. The method according to claim 1, wherein after step a and prior to step c, said method comprises step b: comparing the temperature of said liquid with a first preset temperature.

7. A home soymilk machine comprising a container, a grinding device, and a heating device, the home soymilk machine further comprising:
a level sensor for obtaining a measured value, said measured value being positively correlated with resistance between said level sensor and liquid in said soymilk machine; and
a micro controller unit for
comparing said measured value with a first threshold when the temperature of said liquid is lower than a first preset temperature; comparing said measured value with a second threshold when the temperature of said liquid is higher than said first preset temperature;
and adjusting the power of said heating device if said measured value is lower than or equal to the first threshold when the temperature of said liquid is lower than the first preset temperature; adjusting the power of said heating device if said measured value is lower than or equal to the second threshold when the temperature of said liquid is higher than the first preset temperature.

8. The home soymilk machine according to claim 7, wherein said second threshold is greater than the first threshold; and the power of said heating device is reduced if said measured value is lower than or equal to the first/second threshold.

9. The home soymilk machine according to claim 7, wherein the heating power in the case of the temperature of said liquid being higher than said first preset temperature is lower than the heating power in the case of the temperature of said liquid being lower than said first preset temperature.

10. The home soymilk machine according to claim 7, wherein said first preset temperature is between 95° C. and 97° C.

11. The home soymilk machine according to claim 7, wherein said level sensor is disabled when the temperature of said liquid is lower than a second preset temperature, and said second preset temperature is lower than said first preset temperature.

12. The home soymilk machine according to claim 7, wherein said soymilk machine further comprises a temperature measuring device for measuring the temperature of said liquid.
